(19) United States
(12) Patent Application Publication
(10) Pub. No.: US 2011/0186763 A1
(43) Pub. Date: Aug. 4, 2011

(54) Pressure by-pass valve

(76) Inventors: Kevin W. Lamb, West Hartford, CT (US); Edward A. Voytek, Middlebury, CT (US); Kenneth Lionello, Waterbury, CT (US)

(21) Appl. No.: 12/658,210

(22) Filed: Feb. 4, 2010

(51) Int. Cl. F16K 5/06

(52) U.S. Cl. 251/315.01

(57) ABSTRACT

A by-pass valve fitting assembly in which the valve element is retained in a cage having a front end support rigidly trapped between a cylindrical body and an inlet fitting, with the other end cantilevered in a flow cavity of the body, such that the biasing spring is seated in the cantilevered support to urge the valve element through the front support against a sealing face on the inlet fitting.

### BACKGROUND

The present invention relates to by-pass valves for diverting over pressure flow of liquid.

Hydraulic systems of many varieties often include a pressure by-pass valve either for operational control to activate one portion of the system at high pressure, while isolating that portion during low pressure, or for safety to prevent damage to a lower pressure system.

The basic functionality of such valves is well understood, in that a valve element is biased against a valve seat to prevent flow through the valve up to a threshold pressure, at which pressure the valve member lifts off the seat against the bias of the spring, permitting flow to continue until pressure is reduced and the valve element re-seats. Nevertheless, practitioners in this field continue to look for improvements regarding compact size, reliability, durability, cost, and maintenance.

### SUMMARY

The present invention is directed to a by-pass valve fitting assembly in which the valve element is retained in a cage having a front end support rigidly trapped between a cylindrical body and an inlet fitting, with the other end cantilevered in a flow cavity of the body, such that the biasing spring is seated in the cantilevered support to urge the valve element through the front support against a sealing face on the inlet fitting.

In a generalized embodiment, there is disclosed a by-pass valve fitting assembly comprising a generally cylindrical body with an axially extending flow path from an inlet, through a substantially central internal cavity to an outlet. An inlet fitting is attached to the inlet of the body and has a through bore to the flow path of the body and a valve seat facing the cavity of the body. A ball valve element is situated in the inlet end of the body, and a spring is situated in the cavity for biasing the ball valve element against the valve seat. The spring is retained in a cage, which includes a front support rigidly trapped between the inlet fitting and the body while surrounding the ball valve element, and a back support cantilevered from the front support into the cavity and providing a seat for the spring. In this manner, the spring has one end in the seat of the back support and another end bearing on the ball valve at the front support.

The fully assembled components as described above can have an overall length of less than 5 inches, preferably about 4 inches, with a relief “cracking” pressure on the order of 70+/−10 psi over a temperature range of 80°+/−40° F. The assembly can provide a leakage rate of less than 0.3 gallons per minute at a sustained differential fluid pressure of 45+/−5 psi and temperature of 200°+/−10° F. At a differential pressure up to about 15 psi the flow rate can exceed 8 gallons per minute.

### BRIEF DESCRIPTION OF THE DRAWING

The preferred embodiment will be described with reference to the accompanying drawing, in which:

FIG. 1 is a composite view of the valve fitting assembly in longitudinal section, with respective front and back end views;

FIG. 2 is an axially exploded view of the components shown in FIG. 1;

FIG. 3 is an enlarged view of the spring retainer cage shown in FIGS. 1 and 2;

FIG. 4 is a section view along the lines 4-4 of FIG. 3;

FIG. 5 is an enlarged, longitudinal section view of the body of the fitting assembly shown in FIG. 1;

FIG. 6 is an enlarged longitudinal section view of the inlet fitting of the assembly shown in FIG. 1; and

FIG. 7 is an enlarged sectional view of the cooperation of the body and inlet fitting where the ball valve element is biased against the sealing surface and the front support of the spring cage is rigidly trapped between the inlet fitting and the body.

### DETAILED DESCRIPTION

FIGS. 1-7 show one, preferred embodiment of the invention. The by-pass fitting assembly 10 comprises a generally cylindrical body 12 to which is attached an inlet fitting 14. The body 12 has an integrally formed outlet fitting 16. An inlet through bore 18 is in fluid communication with a flow passage or path 20 through the body 12, whereby hydraulic fluid in through bore 18 can pass through body 12 and out the through bore of fitting 16 only when the ball seal element 22 can be displaced against the biasing force of spring 24, which is held in place by the spring retainer cage 26.

The inlet fitting 14 has external threads 30 which mate with internal threads 22 at the inlet of the body 12 such that the O-ring 28 or the like seats to prevent leakage. The spring retainer 26 has a front seat support 34, a back spring seat support 36, and spanner elements 38a, b, and c rigidly connecting the front and back supports. The back seat support 36 has an inner annular shoulder or surface, against which one end of coil spring 24 is seated. The spring retainer cage 26 is cantilevered from the rigid front support 34 as is best illustrated in FIGS. 5-7.

The body 12 may be considered as having an axial through bore 20 including an inlet end wherein the wall defines a first opening 42 and associated annular shoulder, a second opening 44 and associated annular shoulder, a third opening 46 and associated shoulder, and a fourth opening 48, all of which openings are of successively reduced diameter. The second opening 44 carries internal threads 62. The fourth opening 48 leads to an enlarged, main spring cavity 50 in the flow path 20. The cavity 50 leads to outlet flow bore 52, which is formed in the back wall 54 of the cavity 50. The back portion of the body 12 has an external, preferably hexagonal profile 56, which can be held by a hex wrench for engagement of the inlet end of the body with the inlet fitting 14.

The bore wall 58 of inlet fitting 14 enlarges with a chamfer 60 at inner wall 62 with such chamfer defining the sealing surface or seat for the ball valve element 22. A hex or similar external profile 64 is provided on the inlet fitting 14, with an annular recess 66 situated between the threads 30 and the hex profile 64, whereby the shoulder associated with opening 42 on the body 12 can trap the O-ring 28 there between.

The shoulder associated with the third opening 46 is defined by a radially inner projection 68 which also defines the fourth opening 48. An annular rim or flange portion 70 of the front seat support 34 rests against the upstream shoulder of projection 68. The front support 34 has an inner annular portion 72 which defines an opening 74 that is slightly larger than the diameter of the ball valve element 22, such that the spring 24 can urge the ball valve element 22 without impediment against the seating surface 60 at the inner face 62 of the inlet fitting 14. The inner face 62 bears upon or is closely spaced from the front support 34 to assure that the rim portion 70 is rigidly trapped against projection 68 such that the front support can have no or limited axial movement and no or limited movement transverse to the axis.

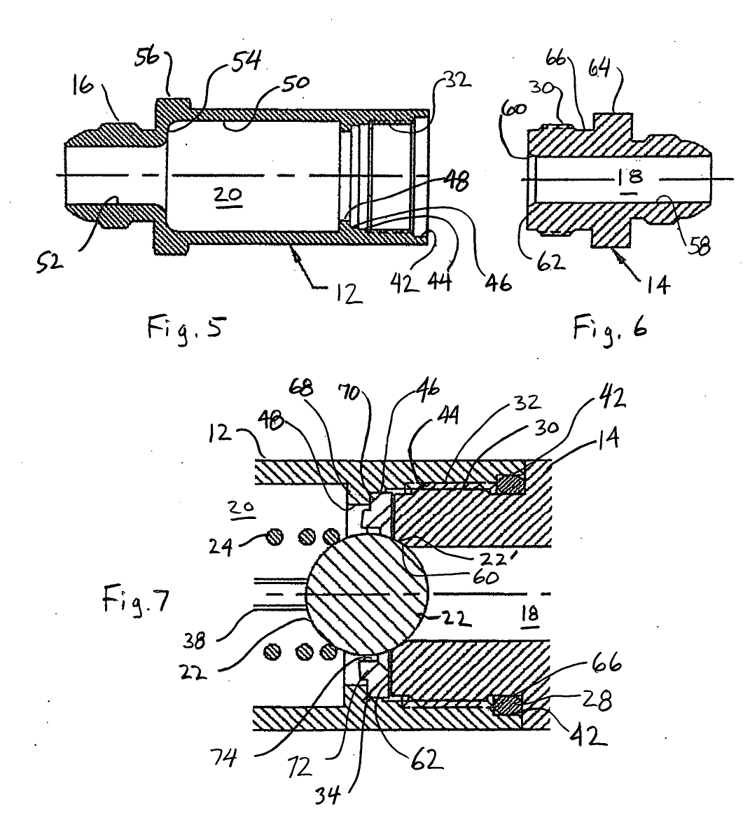

With the front end of spring 24 bearing against the ball valve element 22, it can be appreciated that a circular line contact indicated at 22′ bears against the chamfer seat 60, preventing flow from right to left in FIG. 7 so long as the total force provided by spring 24 against the valve element 22 is greater than the total force resulting from the hydraulic pressure of the fluid in bore 18 against the area of the ball element upstream of the sealing line 22′.

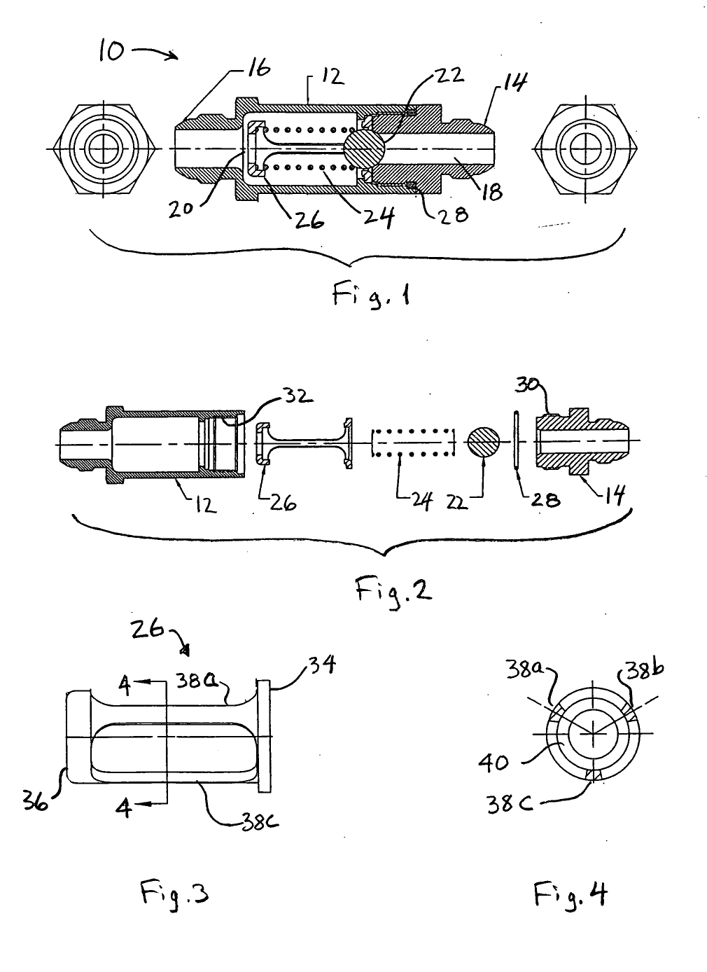

The steps for assembly can be best understood with reference FIG. 2. The spring retention cage 26 with spring 24 retained therein is first slipped into body 12 such that the rim 70 engages the shoulder 46 on the body 12. The valve element 22 can then be inserted given that the diameter of opening 74 in the front support 34 is greater than the diameter of the ball valve element 22, the ball can be inserted into that opening initially, and retained in that opening while the inlet fitting 14 is advanced by the threaded engagement 30, 32. Such advancement results in contact of the seat 60 along line 22′ of the ball 22 while the ball loads the spring 24 until the spring is fully loaded and thereby establishes the target opening pressure.

With the present design, only a few parts are needed and these parts can be quickly assembled without the need for close tolerances. The cage 26 need not be precisely supported at both ends, because it is sufficient for the cage to be cantilevered at the junction of the inlet fitting and the body. The ball valve element need not be precisely aligned within the cage, and likewise the spring need not be precisely aligned within the cage, because the line contact at 22′ of the chamfer portion 60 at the inner face 62 of the inlet fitting 14 will center the other components to the extent needed to assure proper functionality. The multiple spanner elements 38 of cage 26 define a substantially circular sleeve which assists in keeping the spring coaxially aligned but, in addition, the openings between the spanner elements increase the effective flow area (or decrease the effective flow resistance) through the cavity 50 when the valve 22 lifts.

1. A by-pass valve fitting assembly (10) comprising:
a generally cylindrical body (12) with an axially extending flow path (20) from an inlet, through a substantially central internal cavity (50), to an outlet (52);
an inlet fitting (14) attached to the inlet of the body (12) and having a through bore (18) to the flow path (20) of the body (12) and a valve seat (60) facing the cavity (50) of the body;
a ball valve element (22) situated in the inlet end of the body;
a spring (24) situated in the internal cavity (50) and biasing the ball valve element against the valve seat (60);
a spring retention cage (26) including
a front support (34) rigidly trapped between the inlet fitting and the body and surrounding said ball valve element (22);
a back support (36) cantilevered from said front support into said cavity and providing a seat (40) for said spring;
whereby the spring (24) has one end in the seat (40) of the back support and another end bearing on the ball valve (22) at the front support (34).

2. A by-pass valve fitting assembly (10) comprising:
a generally cylindrical body (12) having an axial through bore (20) including an inlet end having an internally threaded (32) portion (44), a counter bore (46) having an associated annular shoulder (68), a substantially central internal cavity (50), and an outlet fitting (16) with outlet bore (52);
an inlet fitting (14) having an inlet end and a through bore (18) extending to an inner face (62) which is chamfered into the inlet through bore (18) and thereby defines a valve seat (60), and an externally threaded region (30) between the inlet end and the face, engageable with the internal threads (32) at the inlet of the body (12);
a ball valve element (22) coaxially situated in the inlet end of the body;
a spring (24) coaxially situated in the internal cavity (50) and biasing the ball valve element against the valve seat (60);
a spring retention cage (26) coaxially extending from said inlet of the body into the body cavity (50), wherein said retention cage includes
a front support (34) trapped between the inner face (62) of the inlet fitting and said shoulder (68) at the entrance to the body and surrounding said ball valve element (22);
a back support (36) situated in said cavity and providing a seat (40) for said spring;
a plurality of spanner elements (38) rigidly connecting the front and back supports;
whereby the spring (24) has one end in the seat (40) of the back support and another end bearing on the ball valve (22) at the front support (34).

3. A by-pass valve fitting assembly (10) comprising:
a generally cylindrical body (12) having an axial through bore (20) including an inlet end having an internally threaded (32) bore portion (44), a counter bore (46) having an annular shoulder (68), a substantially central internal cavity (50), and an outlet fitting (16) with outlet bore (52) extending from a back wall (54) of the cavity;
an inlet fitting (14) having an inlet end and a through bore (18) extending to an inner face (62) which is chamfered into the inlet through bore (18) and thereby defines a valve seat (60), and an externally threaded region (30) between the inlet end and the face, engageable with the internal threads (32) at the inlet of the body (12);
a ball valve element (22) coaxially situated in the inlet end of the body;
a spring (24) coaxially situated in the internal cavity (50) and biasing the ball valve element against the valve seat (60);
a spring retention cage (26) coaxially cantilevered from said inlet end of the body into the body cavity (50), wherein said retention cage includes
a front support (34) rigidly trapped between the inner face (62) of the inlet fitting and said shoulder (68) at the inlet end of the body and surrounding said ball valve element (22);
a back support (36) in spaced relation to the back wall (54) of the cavity (50) and providing a seat (40) for said spring;
a plurality of spanner elements (38) rigidly connecting the front and back supports;
whereby the spring (24) has one end in the seat (40) of the back support and another end bearing on the ball valve (22) at the front support (34).

4. The bypass valve of claim 3, wherein the front support (34) includes an outer annular rim (70) which rests against the shoulder (68).

5. The bypass valve of claim 3, wherein the front support (34) includes an inner annular portion (72) which defines a support opening (74) that is slightly larger than the diameter of the ball valve element (22), such that the spring (24) urges an upstream portion of the ball valve element (22) through the support opening (74) against the seating surface (60) at the inner face (62) of the inlet fitting (14).

6. The bypass valve of claim 4, wherein the front support (34) includes an inner annular portion (72) which defines a support opening (74) that is slightly larger than the diameter of the ball valve element (22), such that the spring (24) urges an upstream portion of the ball valve element (22) through the support opening (74) against the seating surface (60) at the inner face (62) of the inlet fitting (14).

7. The bypass valve of claim 6, wherein the inner face (62) is juxtaposed with the front support (34) whereby rim portion (70) of the front support is trapped against the shoulder (68).

8. The bypass valve of claim 7, wherein the spring (24) bearing against the ball valve element (22) produces a circular line contact (22′) seal between the ball valve element and the seat (60).

9. The bypass valve of claim 8, wherein the ball valve element (22) when sealed has said upstream portion in the inlet through bore (18).

10. The bypass valve of claim 9, wherein the ball valve element (22) remains sealed as long as the total force provided by spring (24) against the valve element (22) is greater than the total force resulting from hydraulic pressure in the inlet through bore (18) against the upstream portion of ball element.

11. The bypass valve of claim 5, wherein the shoulder (68) defines a body opening (48) having a larger diameter than the ball valve element (22), and the inner annular portion (72) of the front support (34) is situated within said body opening (48).

12. The bypass valve of claim 11, wherein an annular seal (28) is provided between the inlet end of the body and the inlet fitting, adjacent the externally threaded region of the inlet fitting engaged with the internal threads (32) at the inlet of the body (12).

13. The bypass valve of claim 11, wherein each of the outlet fitting (16) of the body and the inlet fitting (14) has a raised external profile (56, 64) for engagement with a wrench.
